(19) United States
(12) Patent Application Publication
(10) Pub. No.: US 2006/0272707 A1
(43) Pub. Date: Dec. 7, 2006

(54) Valve device for an inflatable object

(76) Inventor: Hsin-Tsai Wu, Taipei City (TW)

Correspondence Address: GREENBLUM & BERNSTEIN, P.L.C., 1950 ROLAND CLARKE PLACE, RESTON, VA, 20191, US

(21) Appl. No.: 11/359,564

(22) Filed: Feb. 23, 2006

(30) Foreign Application Priority Data
Jun. 6, 2005 (CN) 200520059705.7

(51) Int. Cl. F16K 15/20

(52) U.S. Cl. 137/223

(57) ABSTRACT

A valve device includes a seat body and a valve body having a surrounding abutment member and a flange connected to each other and secured to an inflatable object. The seat body has a plug member which is spaced apart from the abutment member by a communicating port to be in fluid communication with an inflating chamber of the inflatable object, and which has an air passageway extending therethrough to be in fluid communication with the inflating chamber. The valve body has a deformable surrounding wall which is movable between vaulted and depressed positions, and a tubular wall which defines an inflating port. When the deformable surrounding wall is in the depressed position, the inflating port is plugged by the plug member. A check valve is movable relative to the air passageway to permit only introduction of inflating air into the inflating chamber through the air passageway during inflation.

### CROSS-REFERENCE TO RELATED APPLICATION

This application claims priority of Chinese patent Application No. 200520059705.7, filed on Jun. 6, 2005.

### BACKGROUND OF THE INVENTION

1. Field of the Invention

This invention relates to a valve device for an inflatable object, more particularly to a valve device adapted to be secured to an inflatable object for inflation and deflation of the inflatable object.

2. Description of the Related Art

It is known in the art to provide inflatable objects, such as air cushions, beach balls, swimming rings, etc., with inflating valves for filling the same with air and for preventing the escape of air after filling. Referring to FIGS. 1 and 2, a conventional inflating valve 2 is shown to include a seat body 22, a valve body 21, and a rotatable end cap 23 mounted on the valve body 21. The seat body 22 has a plug 222, a plurality of interconnecting ribs 221 which are formed around the plug 222 and which define a plurality of passage holes 223, and a peripheral flange to be attached to the wall of an inflatable object 1 by a high-frequency sealing process. The valve body 21 has a tubular wall 211 which is pluggable by the plug 222 and which defines an inflating port 213 therein, a deformable surrounding wall 212 which is formed around the tubular wall 211, and a peripheral flange which is formed around the deformable surrounding wall 212 for cementation with the peripheral flange of the seat body 22. The deformable surrounding wall 212 is flexible such that it can be moved away from the interconnecting ribs 221 to separate the tubular wall 211 from the plug 222 so as to place the inflating port 213 in communication with the passage holes 223, and such that it can be moved close to the interconnecting ribs 221 to plug the inflating port 213 with the plug 222. However, several problems are encountered in such a construction.

For instance, if the air inside the inflatable object 1 after filling is not sufficient, the end cap 23 has to be removed from the tubular wall 211 to permit the tubular wall 211 to be moved away from the plug 222 for re-inflation process. Once the end cap 23 is removed, air inside the inflatable object 1 may escape, which results in inconvenience during inflation. On the other hand, if the inflatable object 1 is over-inflated and a small amount of air has to be let out of the inflatable object 1, the operation will be difficult to conduct due to the construction of the inflating valve 2.

### SUMMARY OF THE INVENTION

The object of the present invention is to provide a valve device which has an enhanced sealing effect and which permits control of the amount of air to be introduced into or discharged from an inflatable object.

According to this invention, the valve device is adapted to be secured to an inflatable object, and includes a seat body, a valve body and a check valve. The seat body is adapted to be mounted between an access opening and an inflating chamber of the inflatable object, and includes a surrounding abutment member which surrounds an axis, and a plug member which is disposed to extend along the axis, and which is spaced apart from the surrounding abutment member by a surrounding communicating port to be in fluid communication with the inflating chamber. The plug member has upper and lower ends opposite to each other along the axis, and an outer plug surface which surrounds the axis and which is interposed between the upper and lower ends. The upper end has an air passageway which extends through the lower end and which is adapted to be in fluid communication with the inflating chamber. The seat body further includes an interconnecting rib which spans the surrounding communicating port to interconnect the lower end and the surrounding abutment member.

The valve body includes a surrounding flange which surrounds the axis, and which is connected to and which abuts against the surrounding abutment member, a deformable surrounding wall which extends from the surrounding flange towards the axis to terminate at an inner periphery, and which is movable along the axis between a vaulted position, where the inner periphery is remote from the upper end of the plug member, and a depressed position, where the inner periphery is close to the lower end of the plug member, and a tubular wall which extends upwardly along the axis from the inner periphery of the deformable surrounding wall, and which has an inner surrounding surface that defines an inflating port, the inner surrounding surface being configured such that when the deformable surrounding wall is moved to the depressed position, the inner surrounding surface is brought into air-tight engagement with the outer plug surface so as to interrupt fluid communication between the inflating port and the surrounding communicating port. The check valve is disposed to be movable relative to the air passageway along the axis, and is configured to permit only introduction of inflating air into the inflating chamber through the air passageway during inflation of inflatable object from the inflating port.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a conventional inflating valve;

FIG. 2 is a sectional view of the conventional inflating valve when closed;

FIG. 3 is an exploded perspective view of the preferred embodiment of a valve device according to this invention;

FIG. 4 is a sectional view of the preferred embodiment;

FIG. 5 is a sectional view illustrating a valve body of the preferred embodiment in a depressed position; and

FIG. 6 is a sectional view illustrating the valve body in a vaulted position.

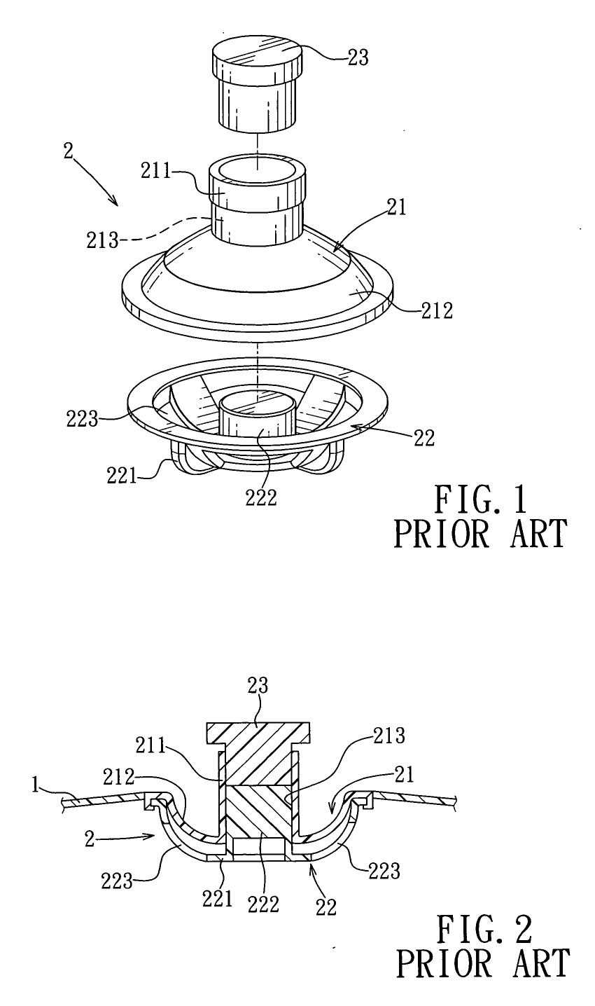

### DETAILED DESCRIPTION OF THE PREFERRED EMBODIMENT

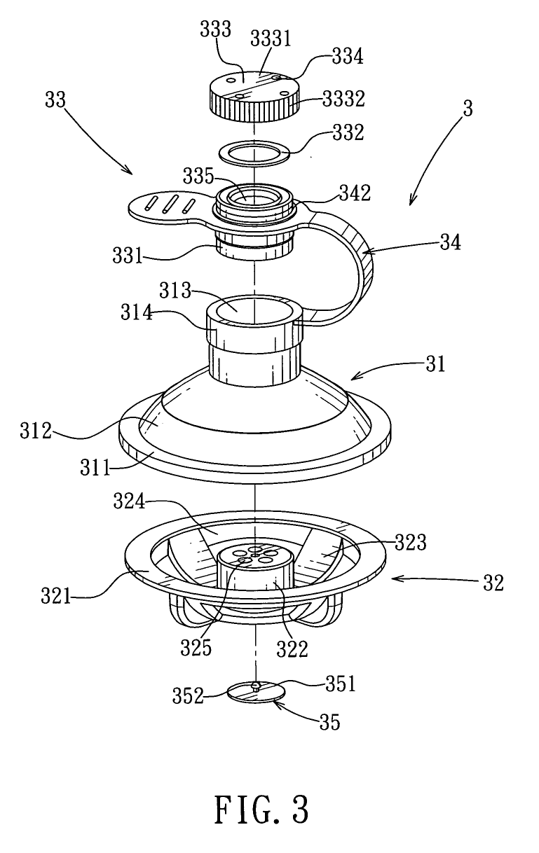

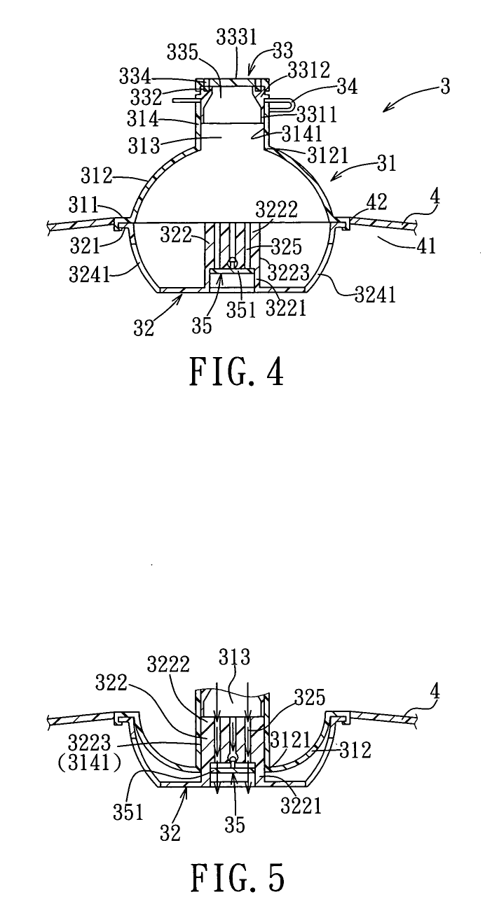

Referring to FIGS. 3 and 4, the preferred embodiment of a valve device 3 according to the present invention is shown to comprise a seat body 32, a valve body 31, a check valve 35, and an end cap assembly 33.

The seat body 32 is adapted to be mounted between an access opening 42 and an inflating chamber 41 of an inflatable object 4, such as an inflatable ball, and is made from a rigid material. The seat body 32 includes a surrounding abutment member 321 which surrounds an axis, a plug member 322 which is disposed to extend along the axis, and which is spaced apart from the surrounding abutment member 321 by a surrounding communicating port 324 that is adapted to be communicated with the inflating chamber 41, and a plurality of interconnecting ribs 323 which span the surrounding communicating port 324 to interconnect a lower end 3221 of the plug member 322 and the surrounding abutment member 321 so as to divide the surrounding communicating port 324 into a plurality of communicating holes 3241. The plug member 322 has an upper end 3222 opposite to the lower end 3221 along the axis, an outer plug surface 3223 which surrounds the axis and which is interposed between the upper and lower ends 3222, 3221. The upper end 3222 has a plurality of air passageways 325 which extend through the lower end 3221 and which are adapted to be communicated with the inflating chamber 41.

The valve body 31 is made from a deformable material, and includes a surrounding flange 311 which surrounds the axis, and which is connected to and which abuts against the surrounding abutment member 321 so as to be attached to the inflatable object 4 by means of sealing process to close the access opening 42, a deformable surrounding wall 312 which extends from the surrounding flange 311 towards the axis to terminate at an inner periphery 3121, and a tubular wall 314 which extends upwardly along the axis from the inner periphery of the deformable surrounding wall 312. The deformable surrounding wall 312 has a frusto-conical shape, and is movable along the axis, as a result of deformation thereof, between a vaulted position, as shown in FIG. 4, where the inner periphery 3121 thereof is remote from the upper end 3222 of the plug member 322, and a depressed position, as shown in FIG. 5, where the inner periphery 3121 is close to the lower end 3221 of the plug member 322.

The tubular wall 314 has an inner surrounding surface 3141 which defines an inflating port 313, and which is configured such that when the deformable surrounding wall 312 is moved to the depressed position, as shown in FIG. 5, the inner surrounding surface 3141 is brought into air-tight engagement with the outer plug surface 3223 of the plug member 322 so as to interrupt fluid communication between the inflating port 313 and the communicating holes 3241.

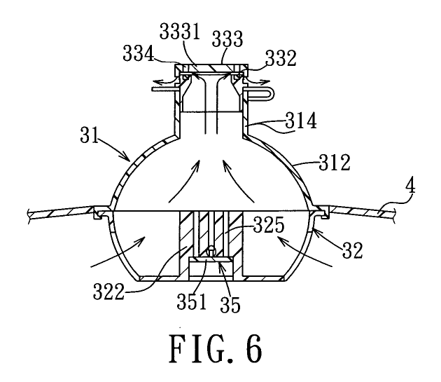

The check valve 35 includes a valve disc 351 and an engaging knob 352 extending from the valve disc 351 to movably engage a middle one of the air passageways 325 such that the valve disc 351 is movable relative to the air passageways 325 along the axis. Thus, during inflation of the inflatable object 4 through the inflating port 313, the valve disc 351 is moved by the inflating air to be away from the lower end 3221 so as to admit the inflating air into the inflating chamber 41 through the air passageways 325, as shown in FIG. 5. On the other hand, during deflation of the inflatable object 4, air inside the inflating chamber 41 forces the valve disc 351 to block the air passageways 325 so as to prevent passage of the air through the air passageways 325, as shown in FIG. 6.

The end cap assembly 33 includes a tubular mount 331, a seal ring 332, a cap member 333, and a connecting strip 34.

The tubular mount 331 defines a communicating channel 335 therein, and has a lower tubular portion 3311 which is configured to be air-tightly engaged with the inner surrounding surface 3141 of the valve body 31 so as to permit the communicating channel 335 to be in fluid communication with the inflating port 313, and an upper tubular portion 3312 which is opposite to the lower tubular portion 3311 along the axis and which has an externally threaded surface. The seal ring 332 is secured to an end edge of the upper tubular portion 3312. The cap member 333 includes a top cap wall 3331 which is disposed to confront the communicating channel 335 along the axis, and a peripheral cap wall 3332 which extends downwardly from a periphery of the top cap wall 3331 and which has an internally threaded surface that engages threadedly the externally threaded surface of the upper tubular portion 3312 such that, by means of screwing movement of the externally threaded surface relative to the internally threaded surface, the top cap wall 3331 is moved between an air-tight position, as shown in FIG. 4, where the internally threaded surface is in full threaded engagement with the externally threaded surface to bring the top cap wall 3331 into air-tight abutment against the seal ring 332 so as to prevent air from escaping out of the communicating channe 1335, and are leasing position, as shown in FIG. 6, where the internally threaded surface is in partial threaded engagement with the externally threaded surface to result in a clearance formed between the seal ring 332 and the top cap wall 3331 so as to permit air in the communicating channel 335 to escape through the clearance to the atmosphere. Moreover, the top cap wall 3331 has a plurality of vent holes 334 formed therethrough and adjacent to the periphery of the top cap wall 3331 to be in fluid communication with the communicating channel 335 such that the seal ring 332 interrupts the fluid communication between the vent holes 334 and the communicating channel 335 when the top cap wall 3331 is in the air-tight position. The connecting strip 34 extends from the tubular wall 314 and terminates at a coupling portion. The coupling portion has a mount hole 342 for extension of the tubular mount 331 therethrough. Alternatively, the tubular mount 331 may be integrally formed with the tubular wall 314 of the valve body 31.

During inflation of the inflatable object 4, the deformable surrounding wall 312 is placed in the vaulted position to permit the tubular wall 314 to be spaced apart from the plug member 322, and the end cap assembly 33 is removed from the inflating port 313. Thus, the inflating chamber 41 can be filled with air through the inflating port 313 and the communicating holes 3241.

When inflation is completed, the lower tubular portion 3311 of the tubular mount 331 is fitted to the tubular wall 314 for closing the inflating port 313. Subsequently, the valve body 31 is depressed to move the deformable surrounding wall 312 to the depressed position such that the tubular wall 314 is plugged by the plug member 322. Since the air pressure in the inflating chamber 41 is larger than the atmospheric pressure, the air in the inflating chamber 41 can force the valve disc 351 to abut against the lower end 3221 of the plug member 322 to close the air passageways 325. Moreover, by the air-tight engagement of the cap member 333 with the seal ring 332, the fluid communication between the vent holes 334 and the communicating channel 335 is interrupted.

When the air in the inflating chamber 41 is not sufficient, the user may remove the cap member 333 from the tubular mount 331, and inflate the inflatable object 4 through the communicating channel 335 so that the inflating air flows through the air passageways 325 to push the valve disc 351 away from the air passageways 325, and enters into the inflating chamber 41, as shown in FIG. 5. Once the inflation is completed, the valve disc 351 will move to abut against the plug member 322 by virtue of the air pressure in the inflating chamber 41.

When the inflatable object 4 is over-inflated, the valve body 31 can be pulled relative to the seat body 32 to move the deformable surrounding wall 312 to the vaulted position, and the cap member 333 can be subsequently rotated to the releasing position so that a clearance is formed between the cap member 333 and the seal ring 332 to allow a desirable amount of air inside the inflating chamber 41 to escape through the clearance.

As illustrated, in this invention, by means of the plug member 322 plugging the tubular wall 314, and the valve disc 351 blocking the air passageways 325, and by virtue of the air-tight engagement between the cap member 333 and the seal ring 332, an enhanced sealing effect can be achieved to prevent undesirable leakage of air from the inflatable object 4. Moreover, due to the provision of the air passageways 325, when the deformable surrounding wall 312 is in the depressed position to enable the tubular wall 314 to be plugged by the plug member 322, only the inflating air is admitted to the inflatable chamber 41 through the air passageways 325. Thus, the air inside the inflatable chamber 41 can not escape through the air passageways 325 once the cap member 333 is removed during inflation. Furthermore, by adjusting the size of clearance between the cap member 333 and the seal ring 332, the amount of air to be pumped into or discharged from the inflating chamber 41 can be regulated.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A valve device adapted to be secured to an inflatable object which has an inflating chamber and an access opening communicated with the inflating chamber, comprising:
a seat body adapted to be mounted between the access opening and the inflating chamber, and including
a surrounding abutment member which surrounds an axis,
a plug member which is disposed to extend along the axis, and which is spaced apart from said surrounding abutment member by a surrounding communicating port that is adapted to be in fluid communication with the inflating chamber, said plug member having upper and lower ends opposite to each other along the axis, and an outer plug surface that surrounds the axis and that is interposed between said upper and lower ends, said upper end having an air passageway which extends through said lower end and which is adapted to be in fluid communication with the inflating chamber, and
an interconnecting rib which spans said surrounding communicating port to interconnect said lower end and said surrounding abutment member;
a valve body including
a surrounding flange which surrounds the axis, and which is connected to and which abuts against said surrounding abutment member,
a deformable surrounding wall which extends from said surrounding flange towards the axis to terminate at an inner periphery, and which is movable along the axis between a vaulted position, where said inner periphery is remote from said upper end of said plug member, and a depressed position, where said inner periphery is close to said lower end of said plug member, and
a tubular wall which extends upwardly along the axis from said inner periphery of said deformable surrounding wall, and which has an inner surrounding surface that defines an inflating port, said inner surrounding surface being configured such that when said deformable surrounding wall is moved to the depressed position, said inner surrounding surface is brought into air-tight engagement with said outer plug surface so as to interrupt fluid communication between said inflating port and said surrounding communicating port; and
a check valve which is disposed to be movable relative to said air passageway along the axis, and which is configured to permit only introduction of inflating air into the inflating chamber through said air passageway during inflation of inflatable object through said inflating port.

2. The valve device of claim 1, wherein said check valve includes a valve disc which is disposed to be movable relative to said lower end along the axis such that during inflation, said valve disc is moved by the inflating air to be away from said lower end so as to admit the inflating air to the inflating chamber through said air passageway, and such that during deflation of the inflatable object, air in the inflating chamber forces said valve disc to block said air passageway so as to prevent leakage of air through said air passageway.

3. The valve device of claim 1, further comprising an end cap assembly disposed to releasably enclose said inflating port.

4. The valve device of claim 3, wherein said end cap assembly includes
a tubular mount which defines a communicating channel therein, and which has a lower tubular portion configured to be air-tightly engaged with said inner surrounding surface of said valve body so as to permit said communicating channel to be in fluid communication with said inflating port, and an upper tubular portion that is opposite to said lower tubular portion along the axis and that has an externally threaded surface formed thereon, and
a cap member including a top cap wall which is disposed to confront said communicating channel along the axis, and a peripheral cap wall which extends downwardly from a periphery of said top cap wall and which has an internally threaded surface that engages threadedly said externally threaded surface such that, by means of screwing movement of said externally threaded surface relative to said internally threaded surface, said top cap wall is moved between an air-tight position, where said internally threaded surface is in full threaded engagement with said externally threaded surface so as to prevent air from escaping out of said communicating channel, and a releasing position, where said internally threaded surface is in partial threaded engagement with said externally threaded surface so as to permit air inside said communicating channel to escape to the atmosphere.

5. The valve device of claim 4, wherein said end cap assembly further includes a seal ring which is interposed between said upper tubular portion and said top cap wall so as to ensure air-tightness therebetween.

6. The valve device of claim 5, wherein said top cap wall has a plurality of vent holes formed therethrough and adjacent to said periphery of said top cap wall to be in fluid communication with said communicating channel such that said seal ring interrupts fluid communication between said vent holes and said communicating channel when said top cap wall is in the air-tight position.

7. The valve device of claim 4, wherein said end cap assembly further includes a connecting strip which extends from said tubular wall and which terminates at a coupling portion, said coupling portion having a mount hole for extension of said tubular mount therethrough.

8. The valve device of claim 4, wherein said lower tubular portion of said tubular mount is integrally formed with said valve body.

9. The valve device of claim 1, wherein said deformable surrounding wall extends upwardly from said surrounding flange in the vaulted position.
